(19) United States
(12) Patent Application Publication
(10) Pub. No.: US 2024/0277553 A1
(43) Pub. Date: Aug. 22, 2024

(54) AMBULATORY SUPPORT DEVICE

(71) Applicant: 9303-2183 QUEBEC INC.

(72) Inventors: Koen DE WINTER, Saint André Avellin (CA); Amiel LAPALME, Laval (CA)

(21) Appl. No.: 18/111,469

(22) Filed: Feb. 17, 2023

(51) Int. Cl. A61H 3/04

(52) U.S. Cl. CPC A61H 3/04; A61H 2003/006; A61H 2201/0107; A61H 2201/0161; A61H 2201/1635; A61H 2201/1676

(57) ABSTRACT

An ambulatory support device comprises an undercarriage configured to travel along a floor surface and to present a pair of upper regions accessible by an ambulatory standing user. Each of the upper regions is configured to receive a respective one of a pair of modular handle structures and which is configured to be releasably coupled to a corresponding upper region. Each of the modular handle structures including a first handle portion, a second handle portion, and a forearm support portion. The first handle portion and the forearm support portion are configured for the ambulatory standing user to navigate the device in a first operative mode with the undercarriage traversing the floor surface. The second handle portion and the forearm support portion are configured for the ambulatory standing user to lift at least a portion of the undercarriage off the floor surface in a second operative mode.

### FIELD OF THE DISCLOSURE

The present disclosure relates to ambulatory support devices and associated structures.

### BACKGROUND

Walkers are common devices which people use to provide guidance and support while walking. Often, the walkers are lightweight and offer handle grips on opposite upper boundaries of the device. While conventional devices provide some support when suitably gripped by the user, further assistance is often needed.

It would thus be desirable to provide novel approaches for such devices and associated structures, or at least to provide the public with one or more useful alternatives.

### SUMMARY

An aspect provides an ambulatory support device comprising:
an undercarriage configured, when operative, to travel along a floor surface and to present a pair of upper regions accessible by an ambulatory standing user,
a pair of handle structures for hand-grippable engagement by the ambulatory standing user,
each of the handle structures including
   a first handle portion,
   a second handle portion, and
   a forearm support portion,
wherein:
   the first handle portion and the forearm support portion are configured for the ambulatory standing user to navigate the device in a first operative mode with the undercarriage traversing the floor surface, and
   the second handle portion and the forearm support portion are configured for the ambulatory standing user to lift at least a portion of the undercarriage off the floor surface in a second operative mode.

The undercarriage may be configured to be deployed between an expanded configuration, when operative, and a retracted configuration, when inoperative.

The first handle portion may be configured to be at an acute included angle relative to the floor surface, when operative.

The undercarriage may include a pair of support structures, wherein each support structure is configured to support a respective handle structure.

Each of the support structures may include a first support portion configured in the expanded configuration to extend from a lower front floor engaging region to an upper handle structure engaging region.

Each of the support structures may include a second support portion configured in the expanded configuration to extend from a lower rear floor engaging region of the undercarriage to a central location along the first support structure.

Each of the first support portions may have a curvature relative to a relatively rearward radial reference region.

Each of the second support portions may have a curvature relative to a relatively forward radial reference region.

Each of the first support portions may include a wheel structure in the lower front floor engaging region to engage the floor surface.

Each of the second support portions may include a pad structure located in the lower rear floor engaging region to engage the floor surface.

The first and second support portions may be movably engaged for relative movement therebetween, between the expanded and retracted configurations.

An example device may further comprise a first traveler structure to movably join the first support portion with the second support portion.

The first traveler structure may be pivotally coupled with the second support portion, to enable the second support portion to travel along the first support portion between the expanded and retracted configurations.

The first support portion may include at least one outwardly extending flange, and wherein the first traveler portion is configured to travel therealong.

An example device may further comprise at least one brace structure configured to extend between the first and second support portions.

An example device may further comprise a second traveler structure movably joining the brace structure with the second support portion.

The second traveler structure may be pivotally coupled with the brace structure to enable the brace structure to travel along the second support portion between the expanded and retracted configurations.

The second support portion may include at least one outwardly extending flange, and wherein the second traveler portion may be configured to travel therealong.

The brace structure may be pivotably coupled at one end thereof to the first support portion.

An example device may further comprise a lock structure to releasably lock the first and second support portions in the respective retracted and/or expanded configurations.

An example device may further comprise a stabilizer structure extending between the support structures to maintain relative positions thereof in the retracted and/or expanded configurations.

The stabilizer structure may include a pair of struts, each of which may be pivotally coupled at one end to a first support portion of one of the support structures, and a traveler portion of another of the support structures.

The struts may be centrally pivotally coupled together.

The first handle portion, the second handle portion and the forearm support portion may be aligned along a common handle structure axis.

The second handle portion may be between the first handle and the forearm support portion.

The second handle portion may be configured with a curved transition in a leading region thereof to provide a location at which an ambulatory standing user can terminate a hand grip to lift at least a portion of the device off the floor in the second operative mode.

Each handle structure may be removably attached to the corresponding upper handle structure engaging region.

The handle and/or the corresponding upper handle structure engaging region may include a releasable locking structure to secure a connection therebetween.

One of the handle structure and/or the upper handle structure engaging region may include an anchor structure configured to enter a corresponding passage in the other of the handle structure or upper handle structure engaging region.

The releasable locking structure may include a first lock element extending outwardly from the anchor structure, wherein the first lock element may be complementary with a second lock element on the upper handle structure engaging region.

The first and second lock elements may include one of a male element and a female element.

An example device may further comprise a pair of hand grip structures, each to engage a corresponding first handle portion.

Each of the hand grip structure and first handle portion may include one or more complementary formations configured to form an interface therebetween to orient each of the hand grips to a designated operative orientation.

At least one of the formations may include at least one elongate receiver on the first handle portion and/or the hand grip structure, to receive a projection formed on the other of the first handle portion and/or the hand grip structure.

At least one of the formations may include a tubular structure with a side wall defining the receiver therealong.

The hand grip structure may include a hand grip body which may be configured and oriented along a central axis thereof to form the designated orientation.

The hand grip body may be custom configurable to one or more physical characteristics of a forearm and/or a hand of the standing ambulatory standing user.

Another aspect provides a handle structure as described in any claim, clause, example or statement herein.

Another aspect provides an ambulatory support device comprising an undercarriage configured to travel along a floor surface and to present a pair of handle structure receiving regions, a pair of modular handle structures, each of which is configured to be releasably coupled to a corresponding handle structure receiving region, each of the modular handle structures including a first handle portion, a second handle portion, and a forearm support portion, wherein the first handle portion and the forearm support portion are configured for the ambulatory standing user to navigate the device in a first operative mode with the undercarriage traversing the floor surface, and wherein the second handle portion and the forearm support portion are configured for the ambulatory standing user to lift at least a portion of the undercarriage off the floor surface in a second operative mode.

One or both of the modular handle structures or portions thereof may be configurable to one or more physical characteristics of a corresponding forearm and/or a corresponding hand of the ambulatory standing user.

An example device may further comprise a plurality of modular handle structures, wherein each modular handle structure or a portion thereof may be configured to suit a corresponding ambulatory standing user configuration.

The plurality of modular handle structures or portions thereof may be arranged in groups of at least two.

Another aspect provides a modular handle structure for removable attachment to an undercarriage of an ambulatory support device, comprising a first handle portion, a second handle portion, and a forearm support portion, wherein the first handle portion and the forearm support portion are configured for the ambulatory standing user to navigate the ambulatory support device in a first operative mode with the undercarriage traversing a floor surface, and wherein the second handle portion and the forearm support portion are configured for the ambulatory standing user to navigate at least a portion of the undercarriage over one or more obstacles on or adjacent the floor surface in a second operative mode.

An example structure may further comprise a mounting portion configured to be releasably coupled to a corresponding upper region of the undercarriage.

One or more of the first handle portion, the second handle portion and the forearm support portion may be custom configurable to one or more physical characteristics of a forearm and/or a hand of the ambulatory standing user.

The first handle portion may be configured to receive a hand grip structure removably attached thereto.

The first handle portion and the hand grip structure may be configured to form an interface therebetween, wherein the interface may be configurable to locate the hand grip structure at a designated position relative to the first handle portion.

The hand grip structure may be configured or configurable to orient a corresponding hand of the ambulatory standing user to a designated pronation or supination.

Another aspect provides an assembly comprising one or more pairs of modular handle structures of any claim, clause, example or statement herein, wherein at least a portion of one or more thereof is configured according to a designated ambulatory standing user configuration.

Another aspect provides a support device for providing ambulatory support along a ground surface, comprising an undercarriage with a pair of opposed ambulatory support structures defining an ambulatory region therebetween, wherein each of the opposed ambulatory support structures provide respective rear ground surface contact regions spaced at a first distance, and respective front ground surface contact regions spaced at a second distance, and wherein the opposed ambulatory support structures are configured to deploy between a retracted configuration and an expanded configuration so that, in the expanded configuration, the first distance is greater than the second distance to provide a relatively wider spacing between the rear ground surface contact regions and a relatively narrower spacing between the front ground surface contact regions.

The undercarriage may include wheel structures at the corresponding front ground surface contact regions, wherein each wheel structure is confined to traverse in line with or relative to a central axis of the undercarriage.

Each wheel structure nay have a corresponding oversteer in relation to the central axis.

Another aspect provides a modular handle structure for removable attachment to an ambulatory support device, comprising a first handle portion, a second handle portion, and a forearm support portion, wherein the first handle portion and the forearm support portion are configured for the ambulatory standing user to navigate the ambulatory support device in a first operative mode with the ambulatory support device traversing a floor surface, and wherein the second handle portion and the forearm support portion are configured for the ambulatory standing user to navigate at least a portion of the ambulatory support device over one or more obstacles on or adjacent the floor surface in a second operative mode.

### BRIEF DESCRIPTION OF THE FIGURES

Several example embodiments of the present disclosure will be provided, by way of examples only, with reference to the appended drawings, wherein:

FIG. 1 is a perspective view of an ambulatory support device in an expanded configuration;

FIG. 2 is a fragmentary side view of a portion of the device of FIG. 1 including a handle structure;

FIG. 2A is an operational side view of the device of FIG. 1;

FIG. 3 is a top view of the device of FIG. 1;

FIG. 4 is a perspective view of the device of FIG. 1 in a retracted configuration;

FIG. 5 is a side view of the device of FIG. 1;

FIGS. 6 to 9 are fragmentary perspective views of a portion of the device of FIG. 1;

FIGS. 10 and 11 are fragmentary perspective views of a portion of the device of FIG. 1 including a handle structure;

FIGS. 12 to 14 are fragmentary perspective views of a portion of the device of FIG. 10 including the handle structure detached from and extended away from a support portion;

FIGS. 15 to 18 are additional fragmentary front elevational or fragmentary downward plan views of a portion of the device of FIG. 1 including the handle structure of FIG. 10;

FIGS. 19 and 20 are rear and front assembly views of a handle structure;

FIGS. 21 to 28 are views of an ambulatory support device in an expanded configuration;

FIGS. 29 to 36 are views of the device of FIGS. 21 to 28 in a retracted configuration; and

FIGS. 37 to 44 are views of a handle structure.

### DETAILED DESCRIPTION

It should be understood that the invention is not limited in its application to the details of construction and the arrangement of components set forth in the following description or illustrated in the drawings. The invention is capable of other example embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical, mechanical or other connections or couplings. The terms upper, lower, vertical and horizontal are intended for operative context only and are not necessarily intended to limit the invention only to those configurations or orientations. Furthermore, and as described in subsequent paragraphs, the specific mechanical and/or other configurations illustrated in the drawings are intended to exemplify embodiments of the invention. However, other alternative mechanical and/or other configurations are possible which are considered to be within the teachings of the instant disclosure. In any instance in which the disclosure refers to a single instance of an element, example embodiments may include a multiple of such elements. The term “at least one” in reference to any element is not intended to force an interpretation on any other reference elsewhere in the disclosure to a single instance of an element to mean only one such instance of the element. Furthermore, the present disclosure provides basis for and encompasses support for any one element, feature, structure, function, of any aspect and/or example embodiment described in the present disclosure including the figures, and/or claims herein, which is itself claimed on its own or combined with any one or more elements, features, structures, functions, and/or steps from the same or any other aspects and/or example embodiments described in the present disclosure including the figures and/or claims herein.

The subject matter herein includes a new, original, and ornamental design for an ambulatory support device, a handle support structure, a modular handle support structure, or any one or more portions thereof, as shown and described in the following specification, with reference being made to the accompanying drawings represented by the figures as identified above which form a part thereof. The subject matter herein includes any of the present figures with any solid line therein replaced by a broken or stippled line. The article is not limited to the scale shown herein.

The term “ambulatory standing user”, ambulatory user, standing user, or user, used herein may include, but is not limited to, a user who is capable (including a user who is temporarily capable) of supporting themselves in a standing position, either with or without ambulatory support devices, such as walkers, but uses an ambulatory support device to move. Such an ambulatory support device providing physical support and psychological comfort to assist the user in their movement and reduce of falls. Such ambulatory support devices are provided in a lightweight or other configuration which can in some cases be collapsed by the ambulatory standing user, in some cases without assistance from a third party.

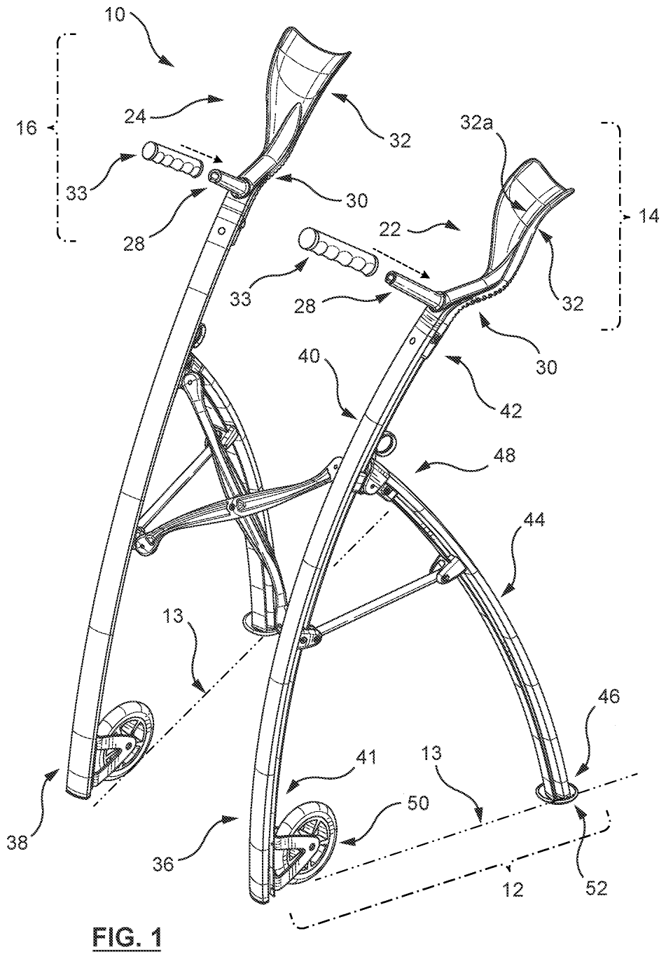

Referring to FIG. 1, there is provided an example of an ambulatory support device (or walker) 10 having an undercarriage 12 which is configured, when operative, to travel along a floor or ground surface, as represented by the chain dotted lines at 13, and to present a pair of upper regions 14 and 16, to be accessible by an ambulatory standing user.

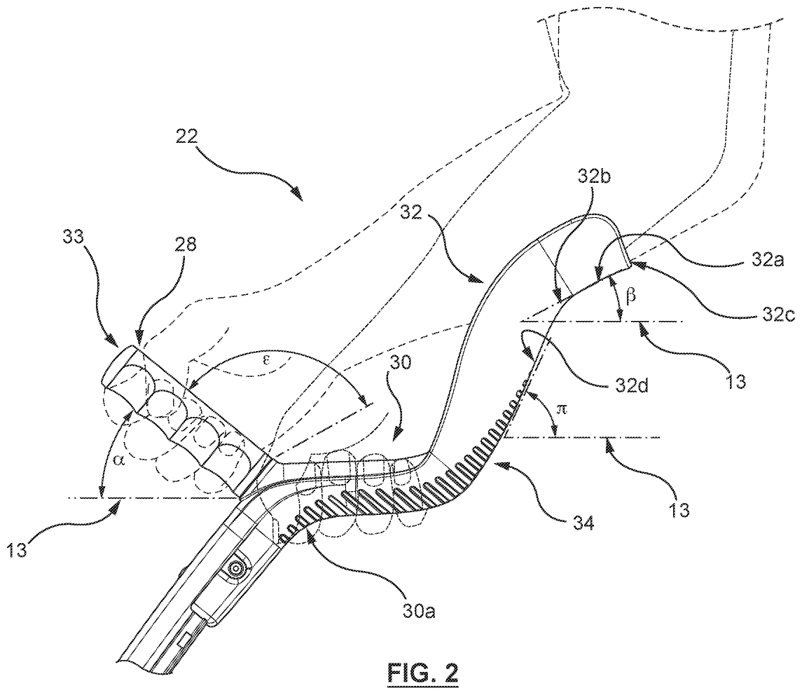

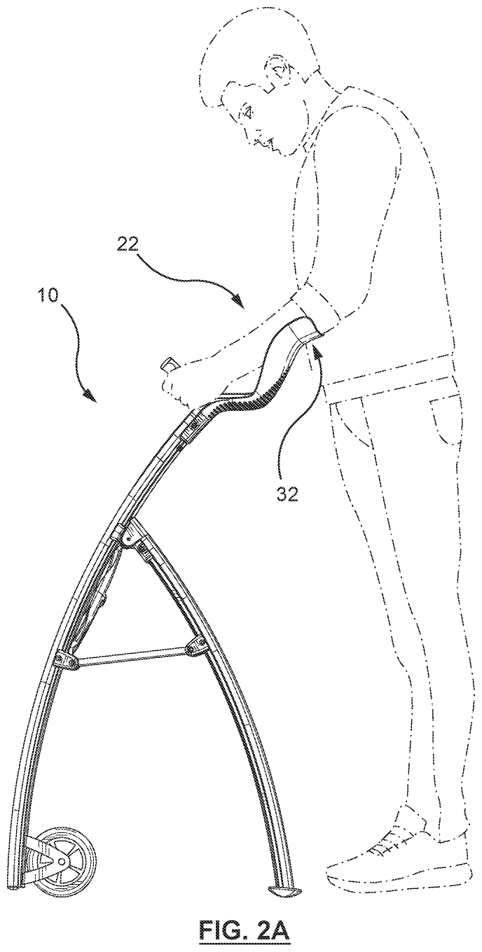

A pair of handle structures 22, 24 may be provided for hand grippable engagement by the standing user. Each of the handle structures 22, 24 may include a first handle portion 28, a second handle portion 30, and a forearm support portion 32. In this case, the first handle portion 28 is configured to receive a first handle grip structure shown at 33. The first hand grip structure 33 is shown in an assembly view, in FIG. 1, to be mounted on the first handle portion 28, and in an installed position thereon, as shown in in FIG. 2. In this example, the first handle portion 28 (together with the first hand grip structure 33) and the forearm support portion 32 may be configured for the ambulatory standing user to navigate the device 10 in a first operative mode with the undercarriage traversing the floor surface 13. This configuration is schematically illustrated in dashed lines in FIG. 2, with the ambulatory standing user's forearm engaging the forearm support portion 32, while the user grips the first hand grip structure 33.

The second handle portion 30 and the forearm support portion 32 may be configured for the ambulatory standing user to lift at least a portion of the undercarriage off the floor surface, in a second operative mode. This configuration is schematically illustrated in condensed dashed lines in FIG. 2, with the ambulatory standing user's forearm continuing to engage the forearm support portion 32, while the user grips the second handle portion 30. The forearm support portion 32 may also be provided with a vaned configuration, providing an array of vanes 34 extending along the region of the handle structure 22 from a location ahead of, or leading, the second handle portion 30 and a location behind or trailing the second handle portion 30. In this case, the vanes 34 may, in some instances, enhance or provide ventilation to a grip by the ambulatory standing user in the second operative mode, while other configurations may also be provided with other formations, surface textures, as well as one or more hand grip structures, for example to present a similar configuration to the user, as the hand grip structures 33. Further, the second handle portion 30 may be configured to transition, in its leading region to a downward curve shown at 30a, to assist in providing the ambulatory standing user with positioning their grip against the downward curve 30a, as a way to aid in navigating or orienting during the lifting of at least a portion of the device 10 in the second operative mode, relative to the floor surface 13.

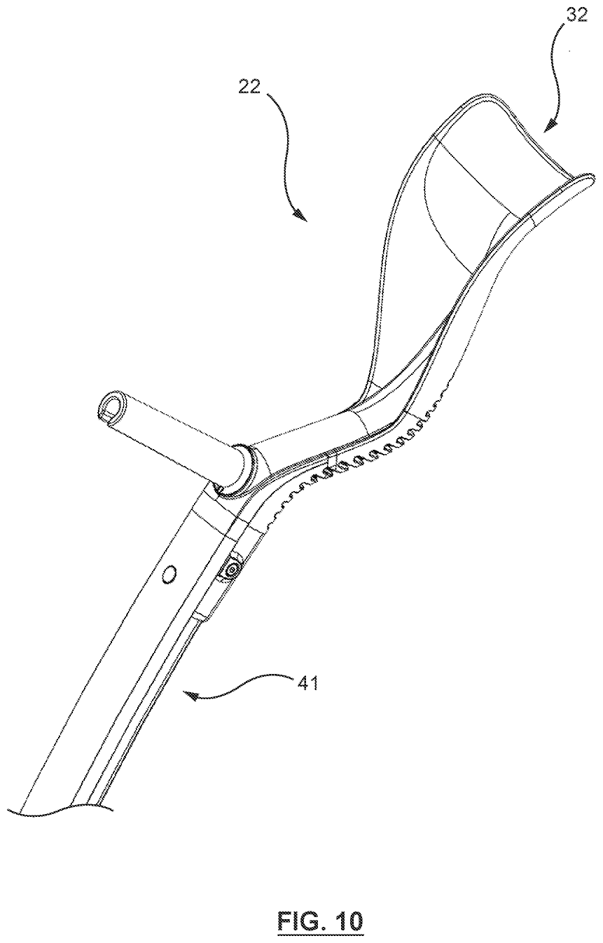

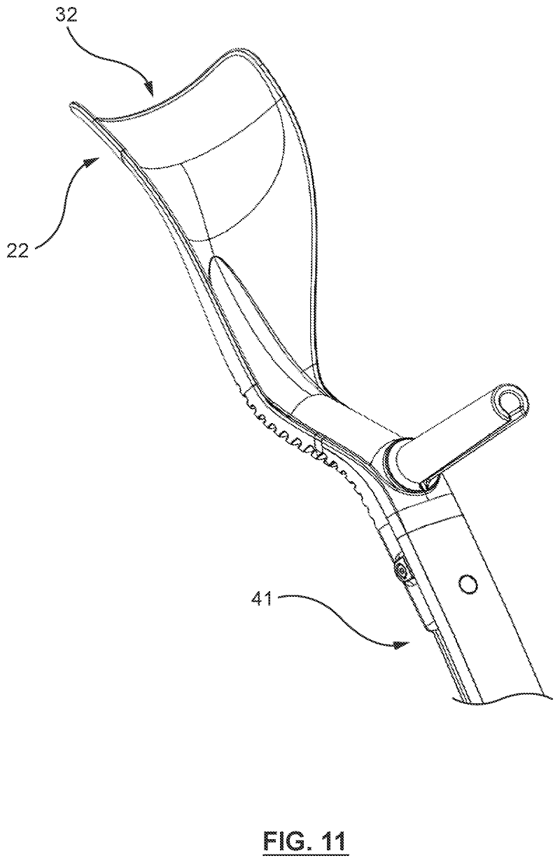

As can be seen in FIGS. 10 and 11, the forearm support portion 32 is U shaped in cross section with the aim of engaging the forearm, and in particular the area of the arm defined by the muscles surrounding the radius and ulna, particularly the larger muscles, namely the lower of three of the four extensors, namely the carpi, digitorum and digiti minimum, to allow the ambulatory standing user to receive balancing support by the device 10. The forearm support portion 32 is intended to terminate ahead of an elbow region of the user's arm, as visualized in FIGS. 2 and 2A.

If desired, the handle structure 22 may be custom configured to closely fit the shape of the ambulatory standing user's arm (or be provided by padding or the like), to maximize both balancing support and comfort. This may be accomplished, for example, by customized handle structures 22 as may be constructed by 3D printing and other similar technologies, for example by carrying out a custom fitting process beforehand.

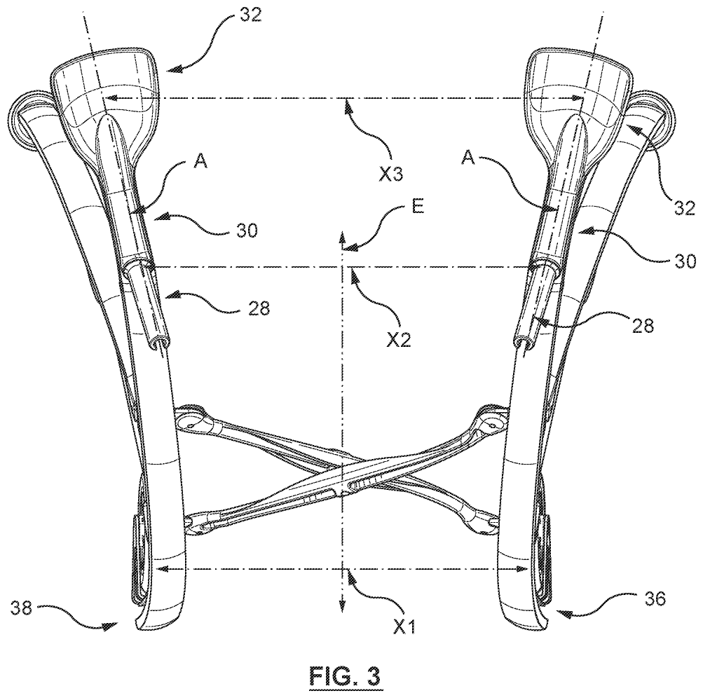

Referring to FIGS. 2 and 3, the first handle portion 28, second handle portion 30 and forearm support portion 32 may be generally aligned along a common handle structure axis A. The second handle portion 30 is shown, in the present example, as positioned between the first handle portion 28 and the forearm support portion 32. In other examples, the first handle portion, the second handle portion and the forearm support portions may be positioned in other relative configurations to enable two modes to navigate the device 10 by the ambulatory standing user.

Referring to FIG. 2, the first handle portion 28 may be configured to be at an acute included angle α relative to the floor surface, as represented by the chain-dotted line at 13, and the second handle portion 30 may be configured to be generally parallel with the floor surface 13, as an example, when operative. The orientation of the first handle portion 28 relative to the second handle portion 30, that is the included angle α may range from about 15 degrees to about 35 degrees, though other angles outside the noted range may also be applicable, and may, in some examples, be configurable to the comfort and support of the ambulatory standing user.

The forearm support portion 32, at its uppermost boundary, may be provided with a surface 32a which, in its central region, may have an included angle β relative to the floor surface, represented by chain-dotted line 13, which may range from about 35 degrees to about 60 degrees, though other angles outside the noted range may also be applicable, and may be configurable to the comfort and support of the ambulatory standing user, enabling the surface 32a to provide support for the forearm, while the user engages the first handle portion 28 in the first operative mode.

The forearm support portion 32 may also provide a transition 32b adjacent the surface 32a and opposite a free edge 32c region thereof, in which the forearm support structure 32 drops away from the central region of the surface 32a to join the second handle portion 30. This configuration may provide the benefit of providing sufficient support in the rear region of the forearm which tends to be fleshy with relatively greater muscle mass and possibly a relatively thicker clothing layer worn by the ambulatory standing user, while the forearm support portion 32 may be otherwise spaced from (i.e. not being in contact with) the front region of the forearm which tends to be less fleshy and may have relatively less muscle mass and relatively thinner clothing layer (if any). Meanwhile, the transition 32b enables the second handle portion 30 to be generally horizontal with the floor surface 13, or at other orientations in which the second handle portion 30 may be gripped to facilitate its use to lift at least a portion of, or navigate, the device 10 over such things as steps and other obstructions that may arise on or adjacent the floor surface 13, such as a transition between adjacent floor surfaces, such as steps and the like.

Referring to FIG. 2, between the transition 32b and the second handle portion 30, the forearm support may be provided with a relatively more steeply inclined inner central surface 32d, which may have an included angle 71 relative to the floor surface, represented by chain-dotted line 13, which may range from about 35 degrees to about 75 degrees, though other angles outside the noted range may also be applicable, and may, in some examples, be configurable to the comfort and support of the ambulatory standing user, enabling the transition 32b and/or the surface 32d to provide support for the forearm, while the user engages the second handle portion 30 in the second operative mode.

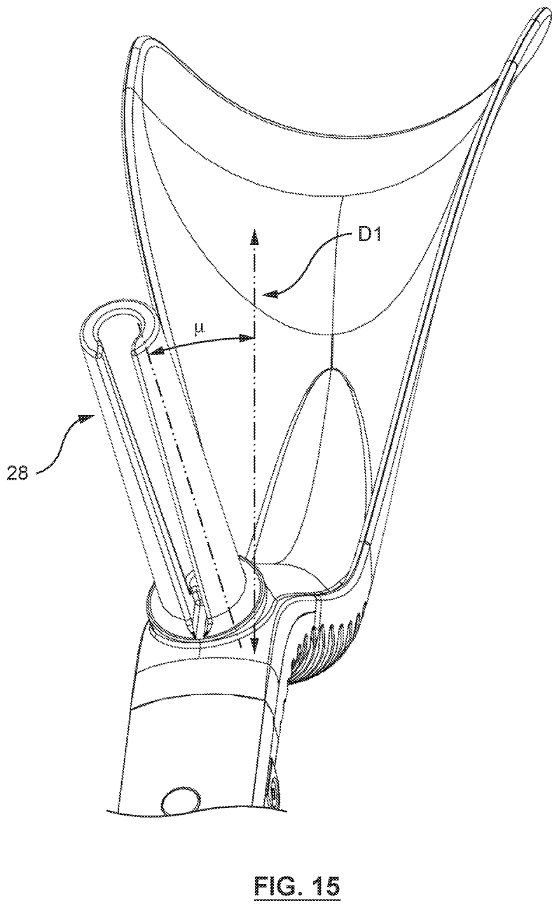

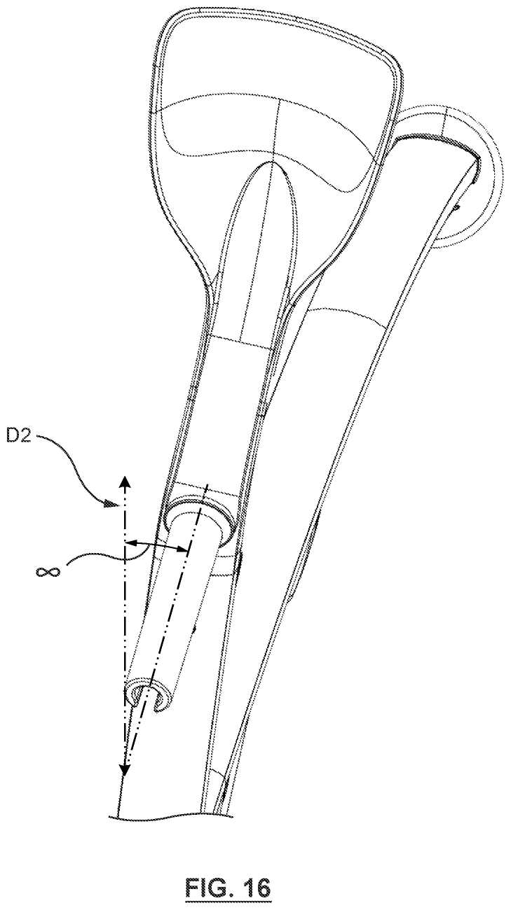

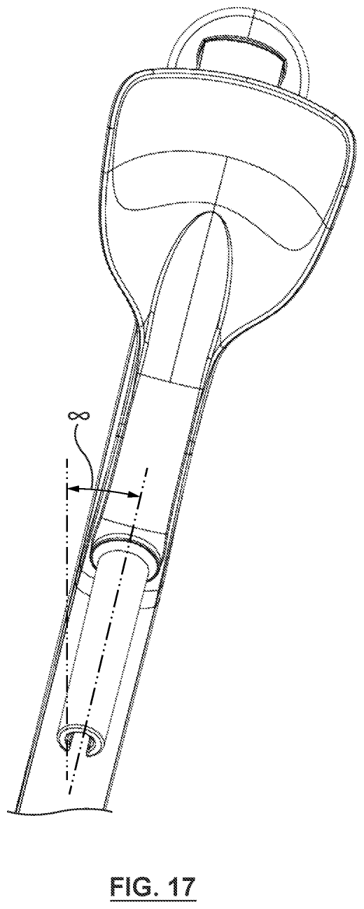

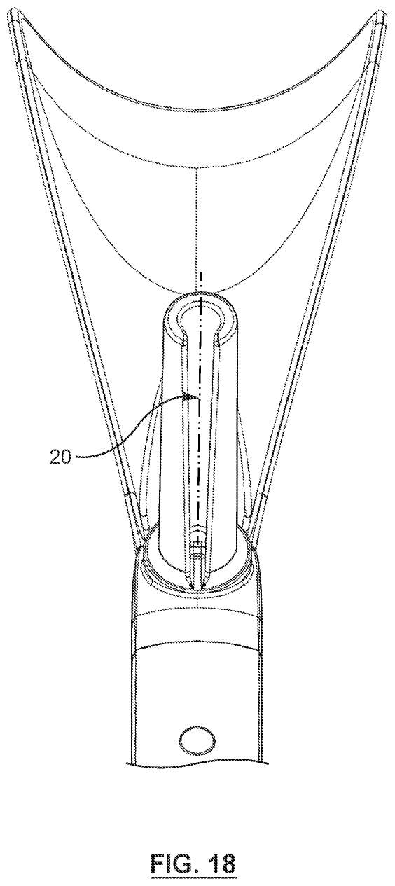

Referring to FIGS. 15, 16 and 17, when looking in a horizontal direction (i.e. generally parallel with the floor surface) as in FIG. 15, the front handle portion may be oriented inwardly as shown by an angle μ relative to a vertical plane D1 which may be generally co-planar with a central plane E of the device as shown in FIG. 3, and/or when looking in a direction downwardly toward the floor surface (as in FIG. 16) by an angle ∞ relative to a vertical plane D2, which similarly may be coplanar with central plane 4, both ranging from about 5 degrees to about 15 degrees, with the device 10 in the expanded configuration, though other angles outside the noted range may also be applicable. This may provide an inward orientation of the first handle portion 28, which may provide added comfort, and which may be needed for some ambulatory standing users, to provide pronation of the hands that may not involve substantial movement of the shoulder or the elbow. Pronation may be identified to occur when an ambulatory standing user dangles their arm down to one side and tries to turn the palm of their hand so that it faces backward, without moving their shoulder. Without being bound by concepts of physiotherapy, in any active position an ambulatory standing user may feel more comfortable with a slight pronation. Such pronation movement may be generated by the radius (one of the two bones in the forearm) necessarily rotating around the ulna, but without the ulna (the other bone in the forearm) changing position. A pronation movement may provide greater stability and comfort for the ambulatory standing user because the elbow and the ulna may remain the same planar position during such movement. In another example, the first handle portion 28 may be oriented outwardly (not shown), which may provide benefits for some users by provide an outward orientation, which may have the effect of causing supination (as occurs when the back of a palm of a dangled hand of an ambulatory standing user faces forward.)

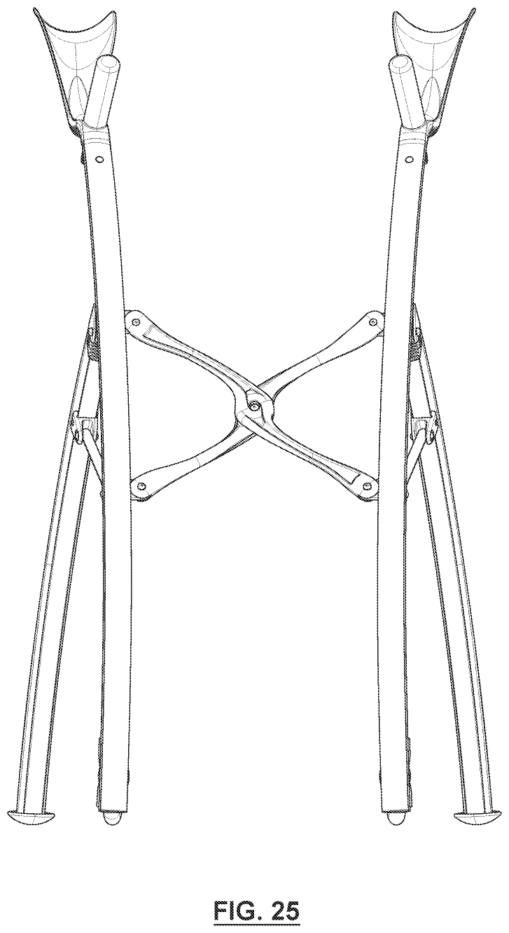

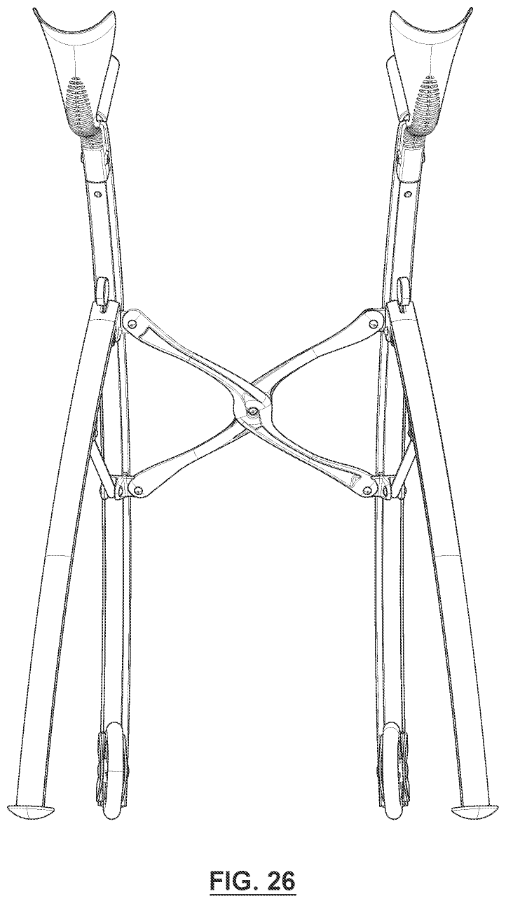

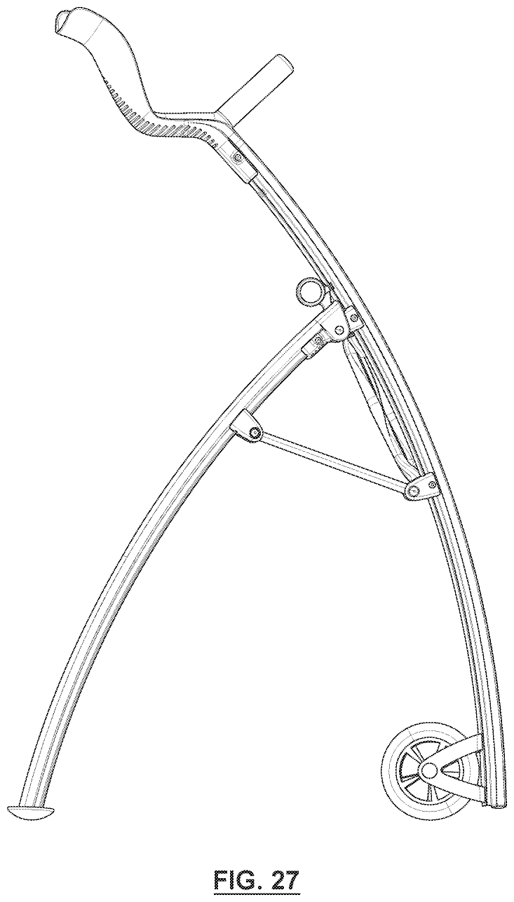

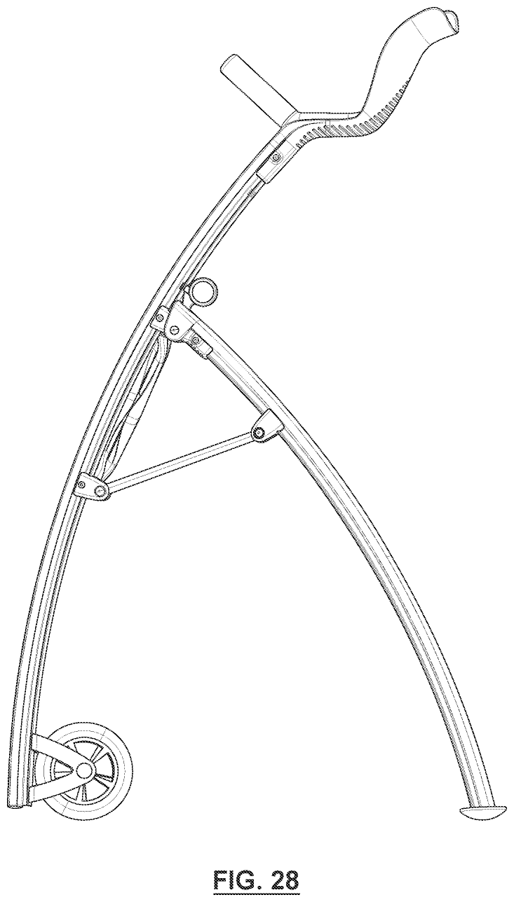

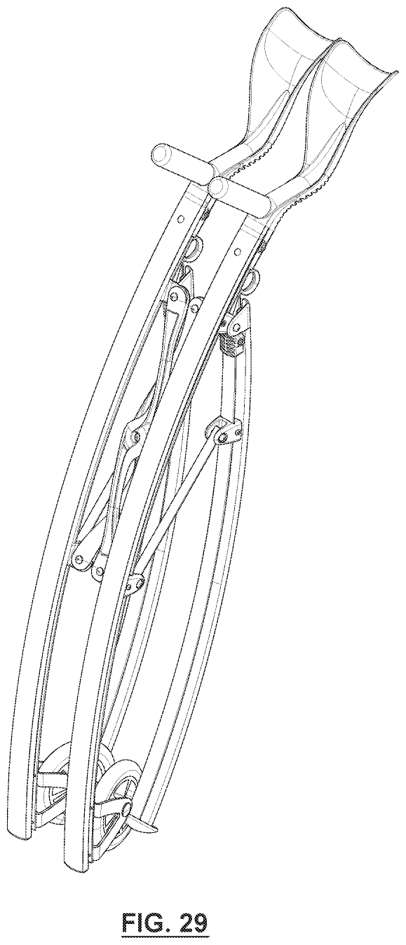

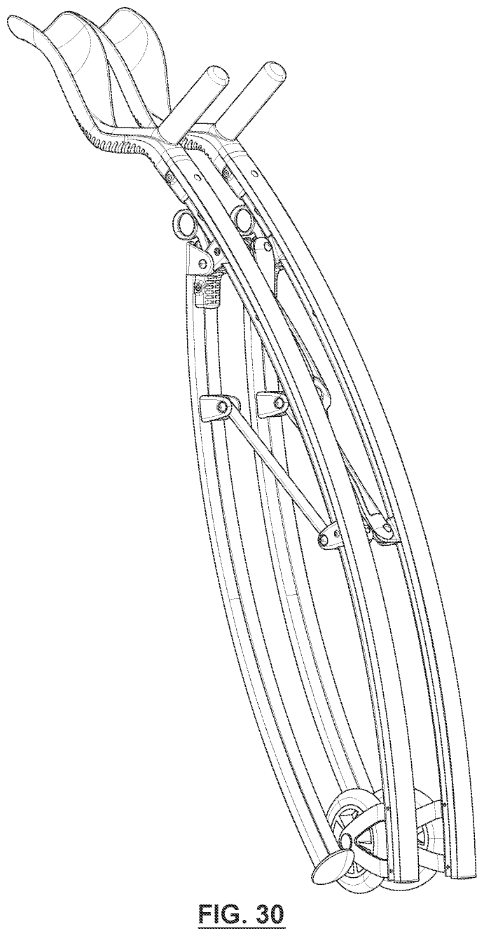

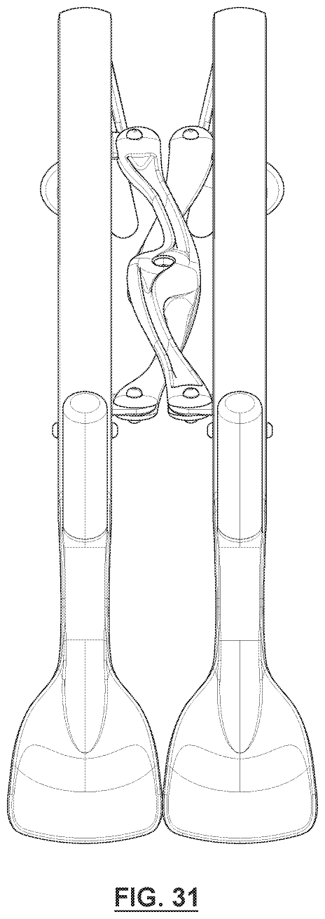

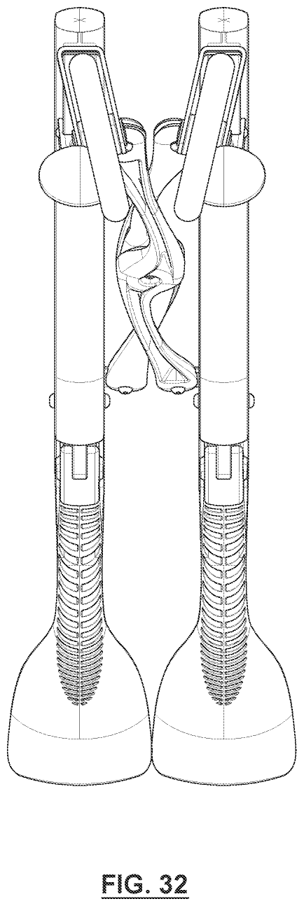

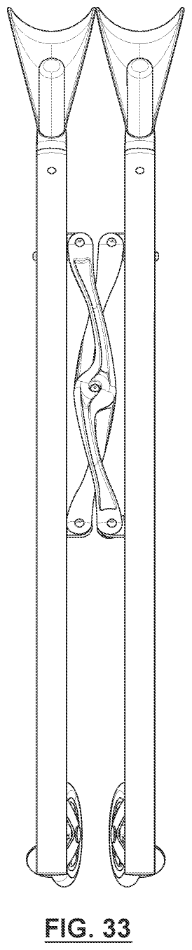

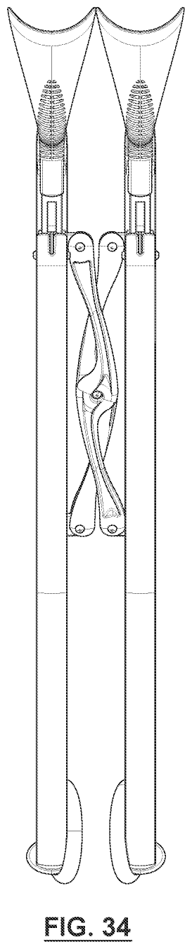

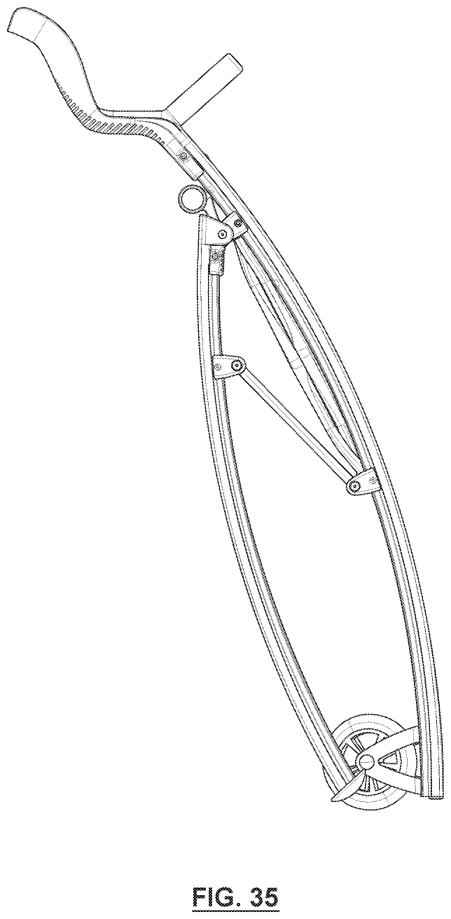

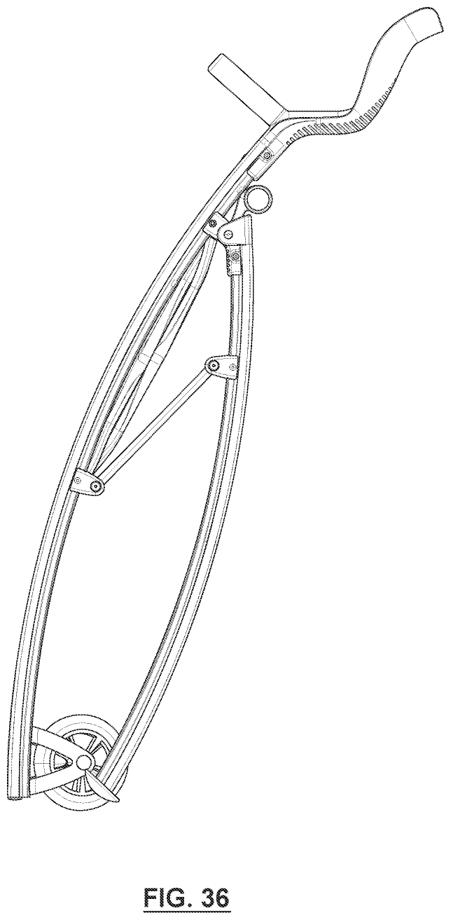

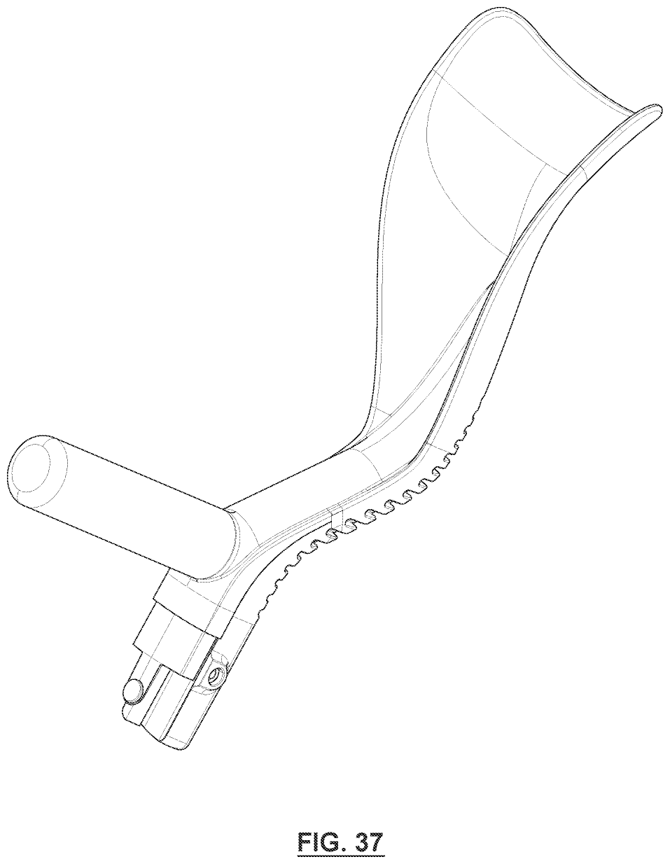

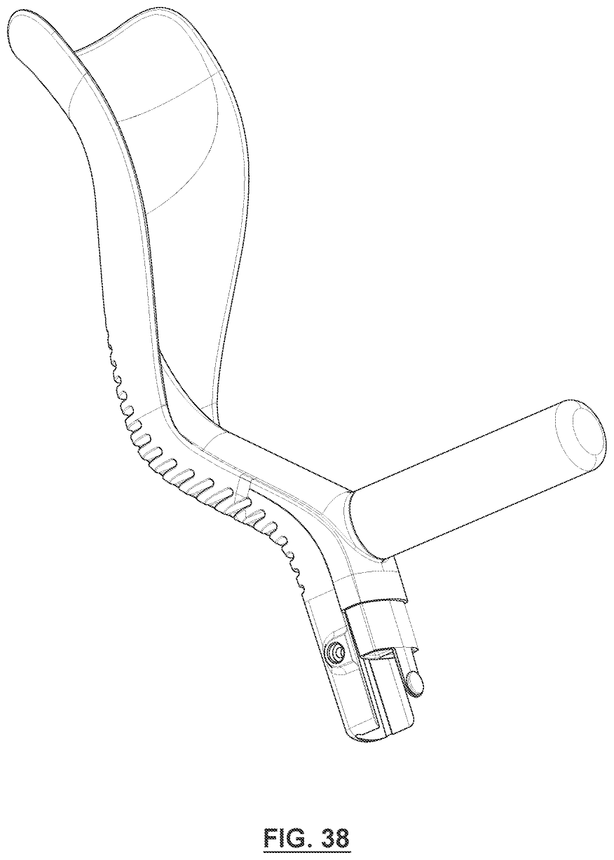

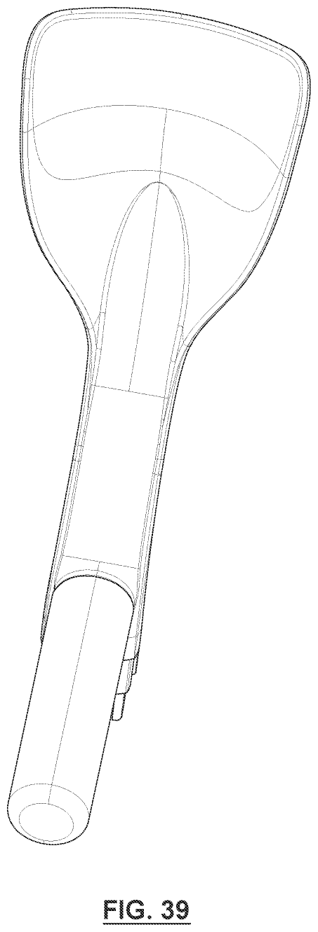

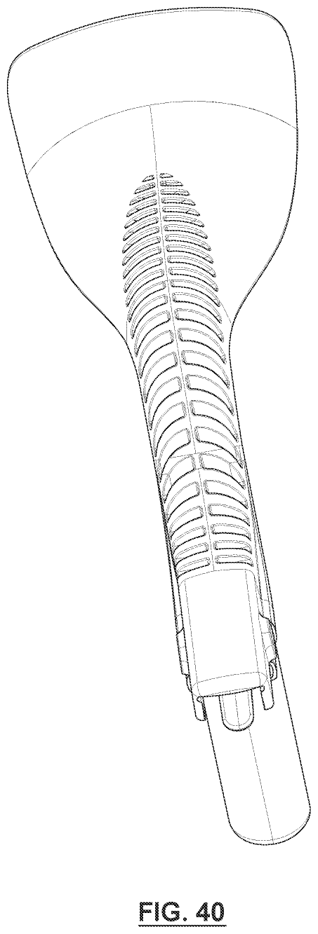

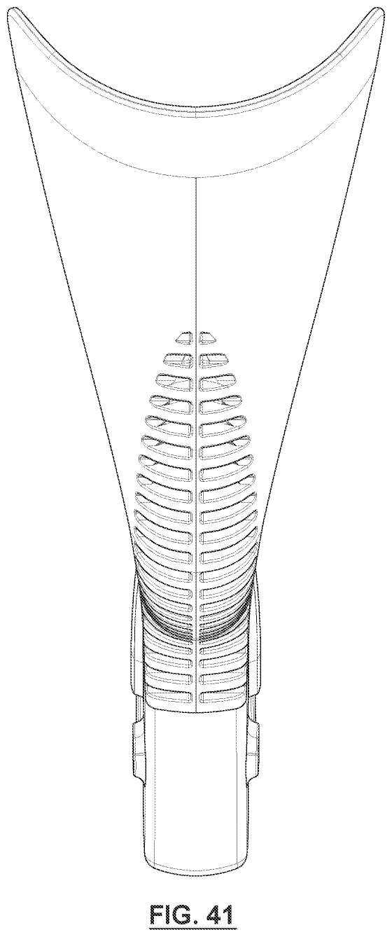

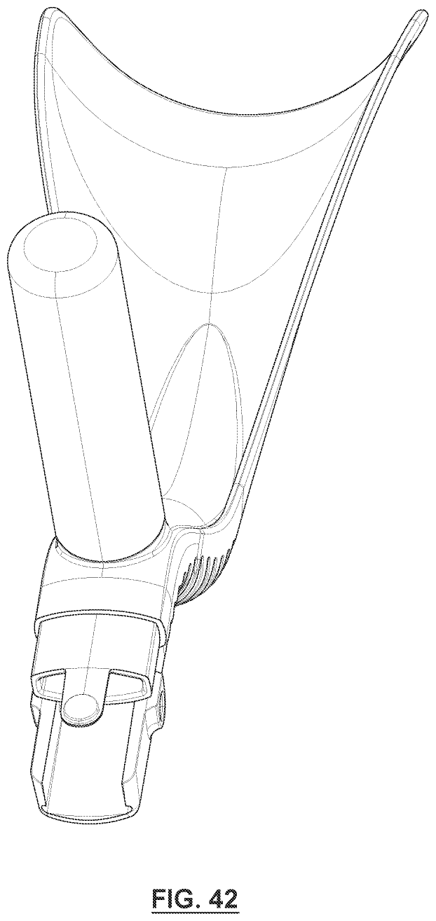

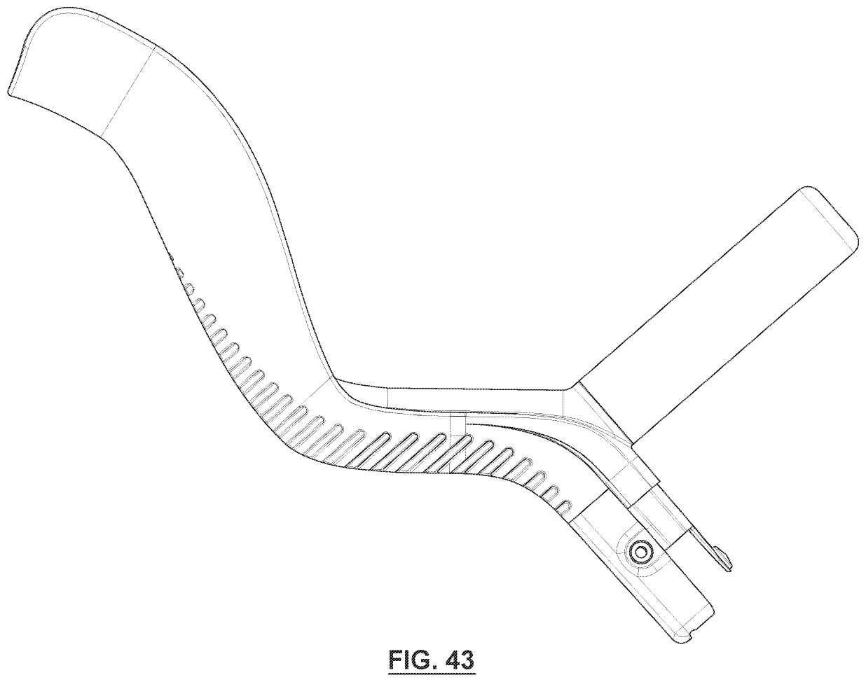

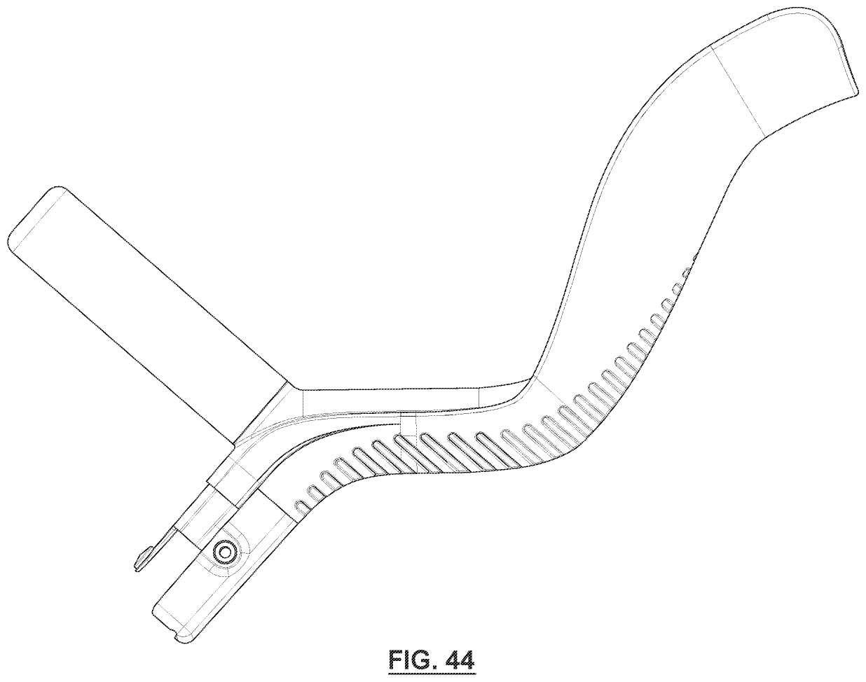

The configuration of the first handle portion 28 and the forearm support portion 32 may provide the benefit of being not only ergonomically and comfortable in providing ambulatory support, they may also provide the user with the sense of “steering”, since the hands are place in a position to some extent reminiscent of the respective locations on a relatively large circular steering wheel of a passenger vehicle, as can be seen in the devices of FIGS. 1 and 25.

Referring to FIG. 1, the undercarriage 12 may include a pair of support structures 36, 38, wherein each support structure is configured to support a respective handle structure 22, 24. Each of the support structures 36, 38 may include a first support portion 40 configured in the expanded configuration to extend from a lower front floor engaging region 41 of the undercarriage 12, to an upper handle structure engaging region 42. Each of the support structures 36, 38 may include a second support portion 44 configured in the expanded configuration to extend from a lower rear floor engaging region 46 of the undercarriage 12 to a central location 48 along the first support portion 40, and further configured to travel along the first support portion 40 as will be described.

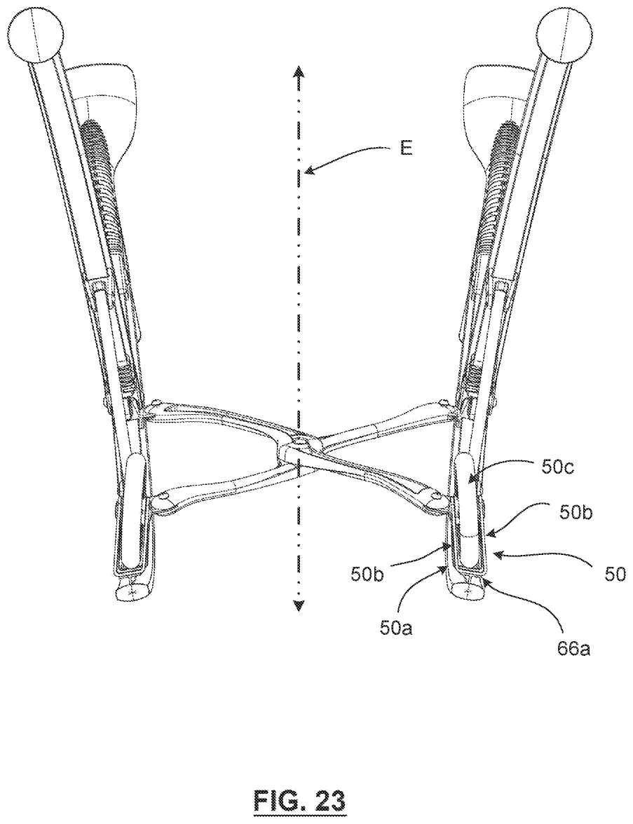

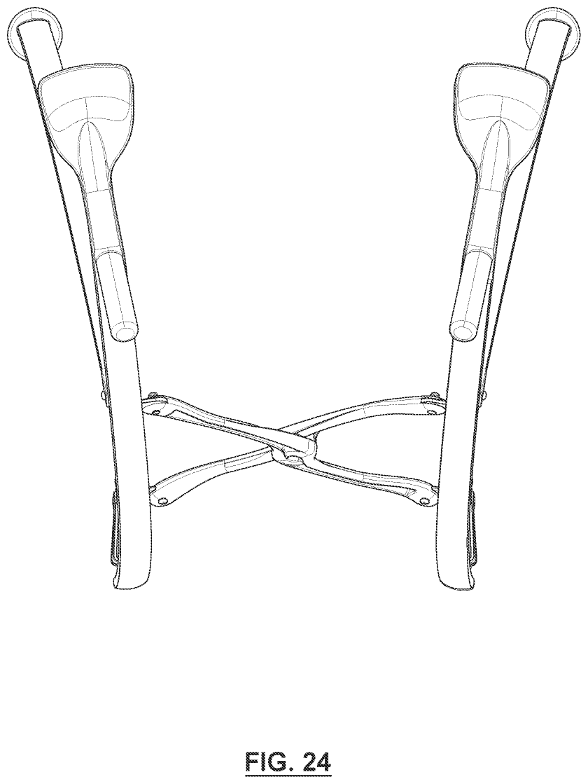

In the case of the device 10 as can be seen in FIG. 3, where the first handle portion 28, second handle portion 30 and forearm support portion 32 may form a unitary body, pronation may thus achieved in a combination of the inward curvature (or bent angle) of the first support portions 40, and the orientation of the undercarriage 12 in which the distance between the wheel structures 50 represented by dimension X1 may be smaller (and thus the distance between the lower portion of the forearm support portions 32 represented by dimension X2), when compared with the distance between the pad structures 52, as represented by dimension X3. Further, the wheel structures 50 may be confined to enable them to be traverse in line with the central plane E. This can be seen in the example of FIG. 23, wherein the wheel structure 50 has a frame structure 50a, with a pair of frame portions 50b supporting a wheel 50c. In this case, the frame structure may be correctively angled relative to the outwardly extending flange 66a to bring the wheel 50c into line with the central plane E, or otherwise with a corresponding oversteer in relation thereto.

Each of the support structures 36, 38 may include at least one wheel structure, such as the wheel structure 50 in the lower front floor engaging region 41 of the first support portion 40. Similarly, each of the support structures 36, 38 may include at least one pad structure, such as the pad structure 52 located in the lower rear floor engaging region 46 providing a low friction floor engaging surface. In other examples, the pad structures 52, and the wheel structures 50 may be replaced by other floor engaging elements. For example, the pad structures 52 may be replaced with wheel structures such as the type shown at 50. Additionally, several configurations of pad structures 52 and wheels 50 may arranged employing the user serviceable removable and attachable components. The configurations may be four wheels, four pads, two wheels in the front and two pads in the rear, fixed axle wheels or castered (pivotal) wheels or combinations thereof, selecting the wheels and pads to provide appropriate support and traction as needed for the particular configuration.

Thus, the device 10 may offer a number of benefits to the ambulatory standing user that may not be found in some types of conventional walkers, which provide handle grips which tend to be horizontal, which may be ergonomically incorrect for their intended use in supporting an ambulatory standing user in a normal course of walking. Such horizontal hand grip orientation may force the ambulatory standing user to bend the wrist, known as ulnar deviation, inappropriately. For a healthy ambulatory standing user, this may not cause pain initially, but nonetheless may provoke unnecessary fatigue. In contrast, a conventional horizontal hand grip orientation may cause immediate pain for ambulatory standing users with osteoarthritis or are in the very beginning of other forms of arthritis which ironically are often conditions which may cause such users to transition to using a walker in the first instance.

In the case of the device 10, as shown in FIG. 2, the first handle portion 28 may be oriented at an angle C relative to central region of the surface 32d, which may range from about 95 degrees to about 115 degrees, though other angles outside the noted range may also be applicable. In some examples, this may provide the effect of placing the first handle portion 28 at slightly beyond a 90 degree orientation relative to the forearm support portion 32. In addition, the inward orientation of the front end of the frame at the wheel structures 50, as shown in FIG. 3 by the distance X1 therebetween, and relative to the outward orientation of the rear end of the undercarriage 12 at the frame at the pad structures 52 as shown by the distance X2 therebetween, enables the distance between the first handle portions 28 to be relatively smaller than the corresponding distance between the forearm support portions 32. This may be desirable for some ambulatory standing users to provide “grip locations” in positions which in some cases may reduced, if not substantially eliminate, ulnar deviation, while providing a slight pronation of the wrist. These two characteristics may combine to place the ambulatory standing user's arm in a neutral and relaxed position. Pronation may also provide a more comfortable “steering” of the front wheels, which in some instances may provide a similar benefit from a principle in vehicle steering design by providing “over-steering” by letting wheel structures 50 converge slightly (such as by 0.5°) so when the driver turns the steering wheel, they would have the feeling of being assisted (pulled in the chosen direction). In the present case, the wheel structures 50 may be configured to converge slightly to achieve a similar effect.

Supination and radial deviation tend not to be provided in traditional generic walkers, which are thus not able to accommodate for a relatively small ulnar deviation to a neutral position as may be provided by the device 10. Flexion may be experienced by obese “users”, and extension by a relatively small proportion of users. With the device 10, on the other hand, neither flexion nor extension is encouraged.

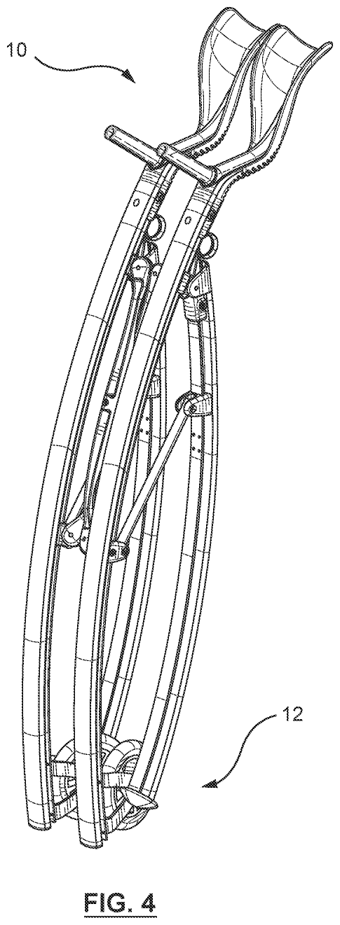

The undercarriage 12 may be configured to be deployed between an expanded configuration, when operative, as shown in FIG. 1, and a retracted configuration, when inoperative, as shown in FIG. 4. In other examples the undercarriage may be configured to remain in the expanded configuration.

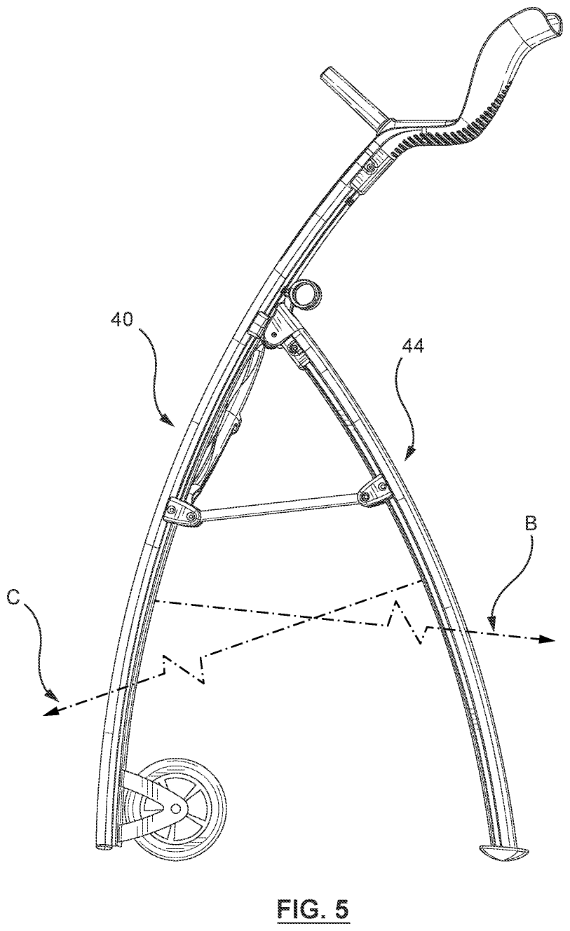

Referring to FIG. 5, each of the first support portions 40 may have a curvature relative to a relatively rearward radial reference region, shown schematically by arrow B, while each of the second support portions 44 may have a curvature relative to a relatively forward radial reference region, shown schematically by arrow C.

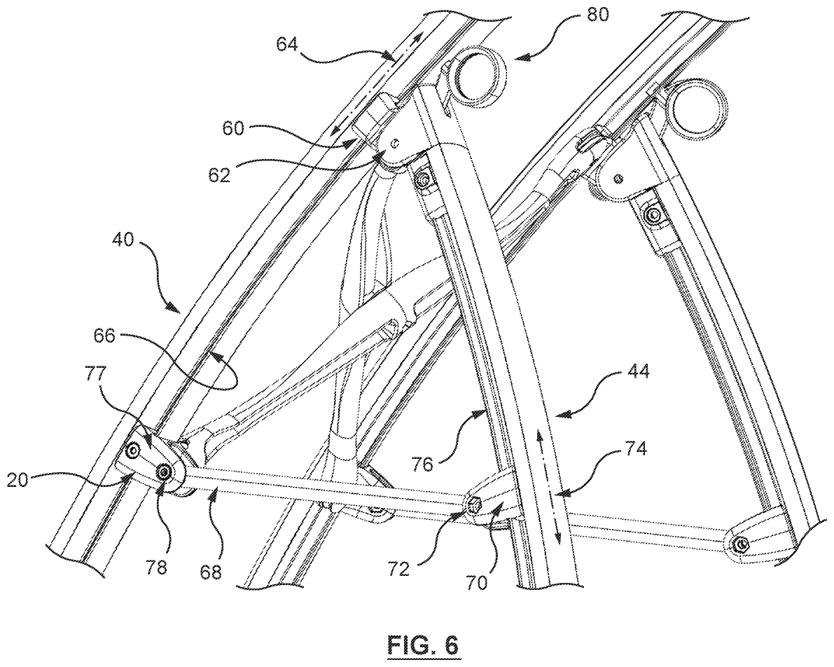

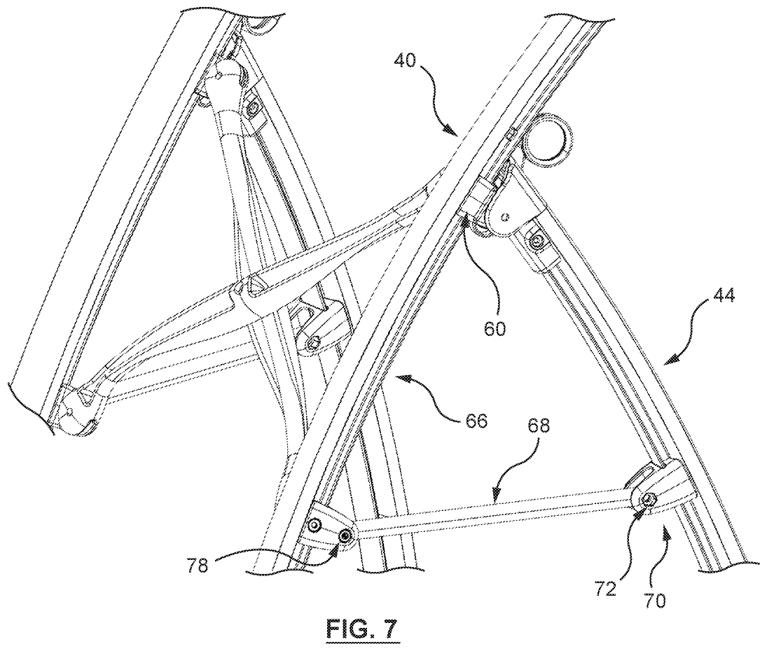

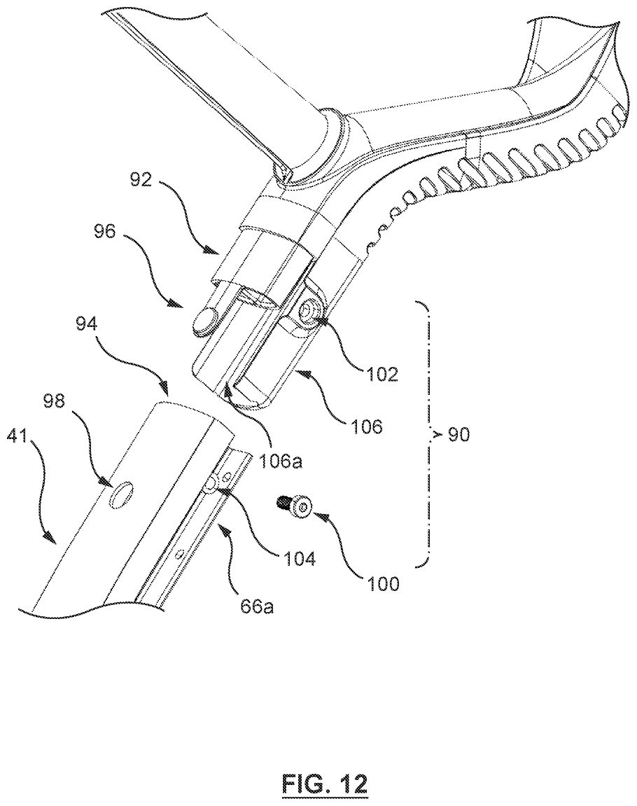

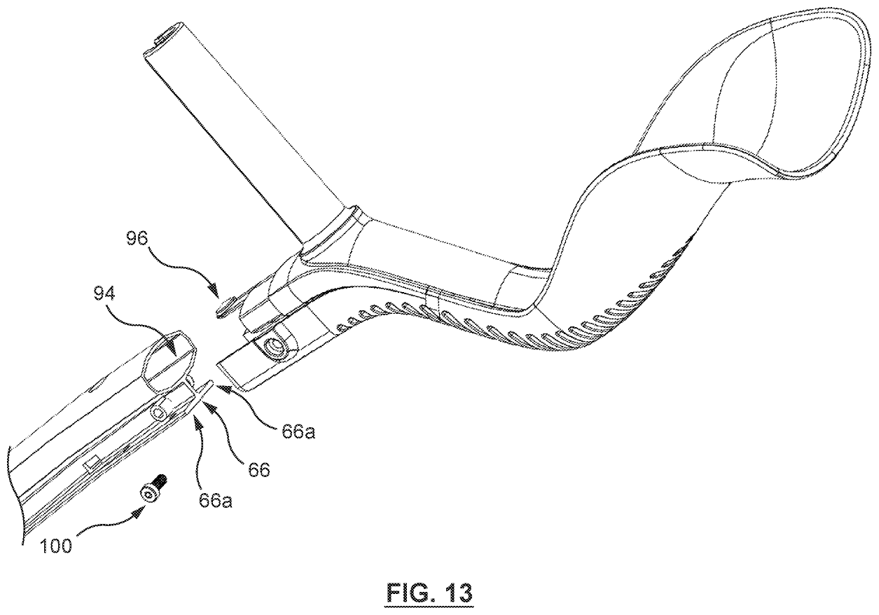

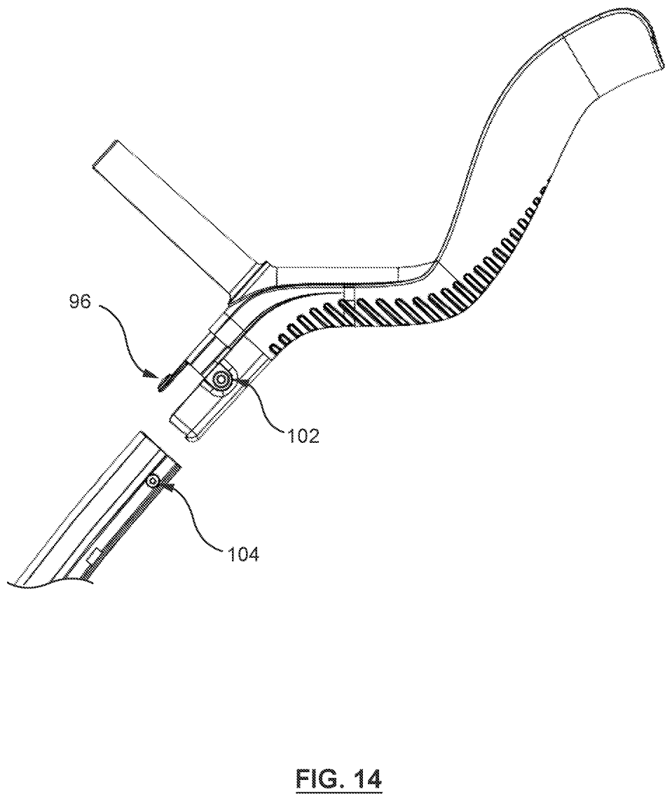

Referring to FIGS. 6 to 9, the first and second support portions 40, 44 may be movably engaged for relative movement therebetween between the expanded and retracted configurations of FIGS. 1 and 4 respectively. In this example, a first traveler structure 60 may movably join the first support portion 40 with the second support portion 44. The first traveler structure 60 may be pivotally coupled with the second support portion 44 at pivot point 62, to enable the second support portion 44 to travel along the first support portion 40 between the expanded and retracted configurations, as represented by travel path 64. The first support portion 40 may include at least one outwardly extending flange 66, which may be provided in the form of opposed flanges 66a, as shown in FIGS. 12 and 13, and wherein the first traveler structure 60 may be configured to travel therealong.

Referring to FIG. 6, a brace structure may be provided as shown at 68, which may be configured to extend between the first and second support portions 40, 44. A second traveler structure 70 may movably join the brace structure 68 with the second support portion 44. For example, the second traveler structure 70 may be pivotally coupled with the brace structure at pivot point 72, to enable the brace structure 68 to travel along the second support portion 44 between the expanded and retracted configurations, along travel path 74. The second support portion 44 may include at least one outwardly extending flange 76, which may be provided in the form of opposed flanges, which may be equivalent to opposed flanges 66a, and wherein the second traveler portion 70 may be configured to travel therealong. The brace structure 68 may be pivotably coupled at one end thereof to the first support portion 40 by way of a pivot anchor structure 77 at pivot point 78.

As can be seen FIGS. 3 and 6, the brace structures 68, between the first and second support portion of both support structures 36, 38, may be configured to enable the support structures 36, 38 to be folded at the same time, as the second support portions 44 fold into the first support portions 40. Furthermore, the braces, combined with the first and second traveler structures 60, 70, enable the support structures 36, 38 and first and second support portions 40, 42 to deploy to an expanded configuration in which the rear of the undercarriage 12, as defined by the second support portions 44 terminating at the pad structures 52, opens to a relatively wider stance as shown by dimension X3, compared with the relatively narrow stance of the first support portions 40 terminating that the respective wheel structures 50 (as shown by dimension X1).

Referring to FIG. 6, a latch structure 80 may releasably lock, clamp or otherwise releasably fix the first and second support portions 40 and 44, in the respective retracted and/or expanded configurations. In this case, the latch structure 80 may be configured to engage a portion of include a pin or similar structure to set within pre-located receiver passages, not shown, corresponding to the respective retracted and/or expanded configurations, or provide another form of transition between clamped and unclamping effects.

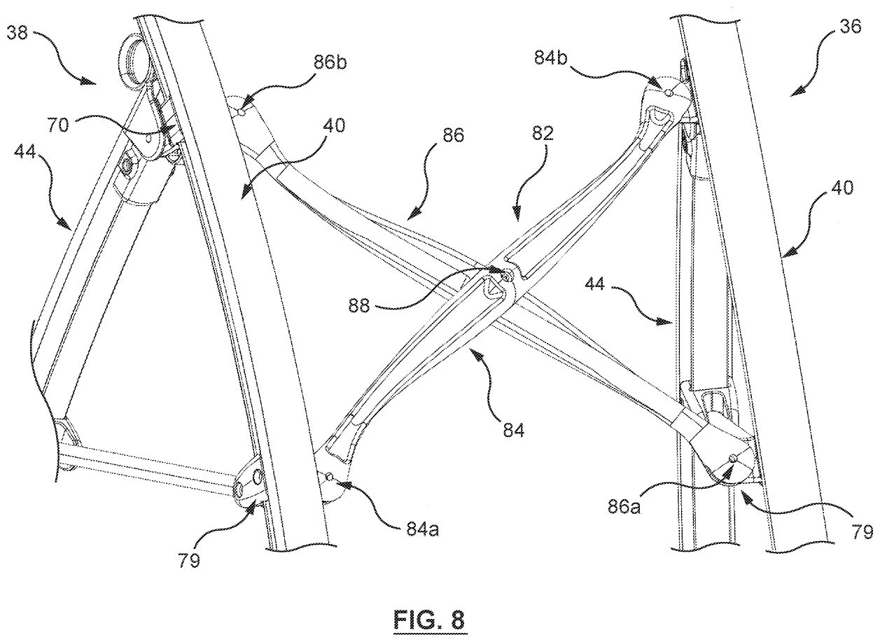

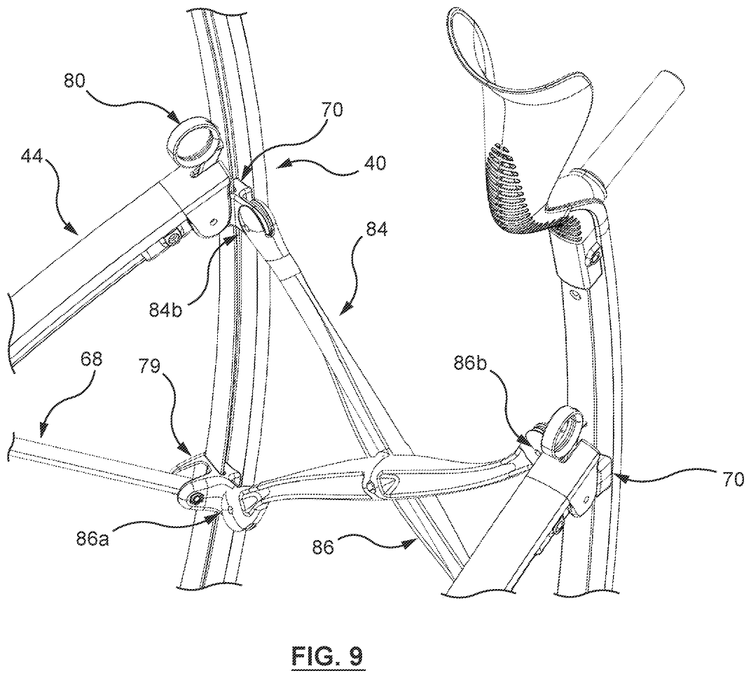

Referring to FIGS. 8 and 9, a stabilizer structure 82 may extend between the support structures 36, 38 to maintain relative positions thereof in the expanded and retracted configurations of FIGS. 1 and 4 respectively. The stabilizer structure 82 may include a pair of struts 84, 86, each of which may pivotally coupled at one end to a pivot point location relative to a respective first support portion 40, as shown at pivot points 84a, 86a, provided on the respective pivot anchor structure 79, and at another end to the respective first traveler structure 70 on the opposite first support portion, as shown at pivot points 84b, 86b. The struts 84, 86 may additionally centrally pivotally coupled together at pivot point 88.

Referring to FIGS. 10 to 13, each handle structure 22 may be a modular handle structure, and may be removably attached to the corresponding upper handle structure engaging region 41. For example, each handle structure 22 and/or the corresponding upper handle structure engaging region 41 may include releasable locking structure 90 to releasably secure the connection therebetween. The handle structure 22 may include a first anchor structure 92 configured to enter a corresponding passage 94 in the upper handle structure engaging region 41. The releasable locking structure 90 may include a first lock element 96 extending outwardly from the first anchor structure 92, while the first lock element 96 is complementary with a second lock element 98 on the upper handle structure engaging region 41. The first and second lock elements may include a respective one of a male element and a female element. Further, a locking screw or similar structure, shown at 100, may be received by aligned passages 102, 104 respectively, in a second anchor structure 106 and the upper handle structure engaging region 41. In this case, the second anchor structure 106 engages the opposed flanges 60a in corresponding recesses 106a.

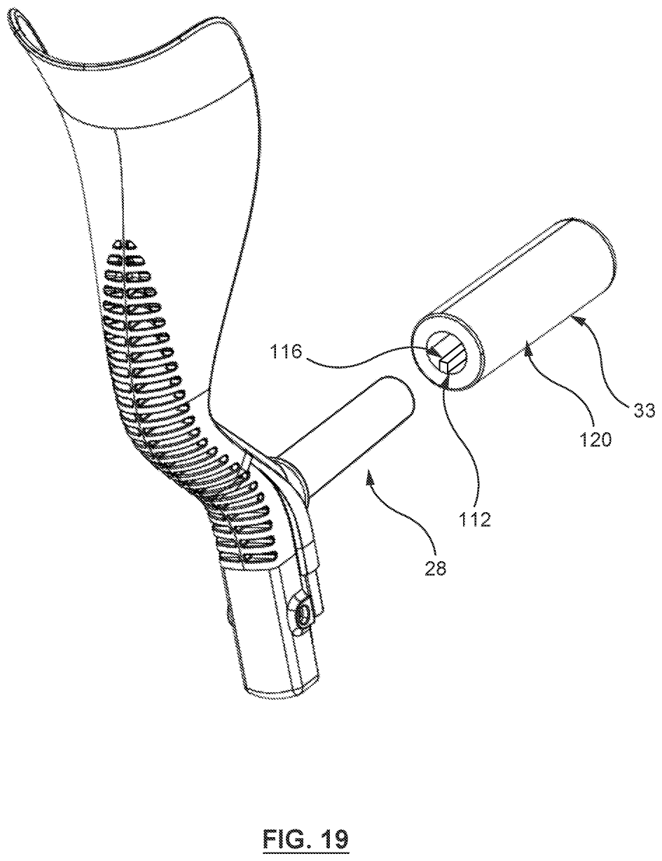

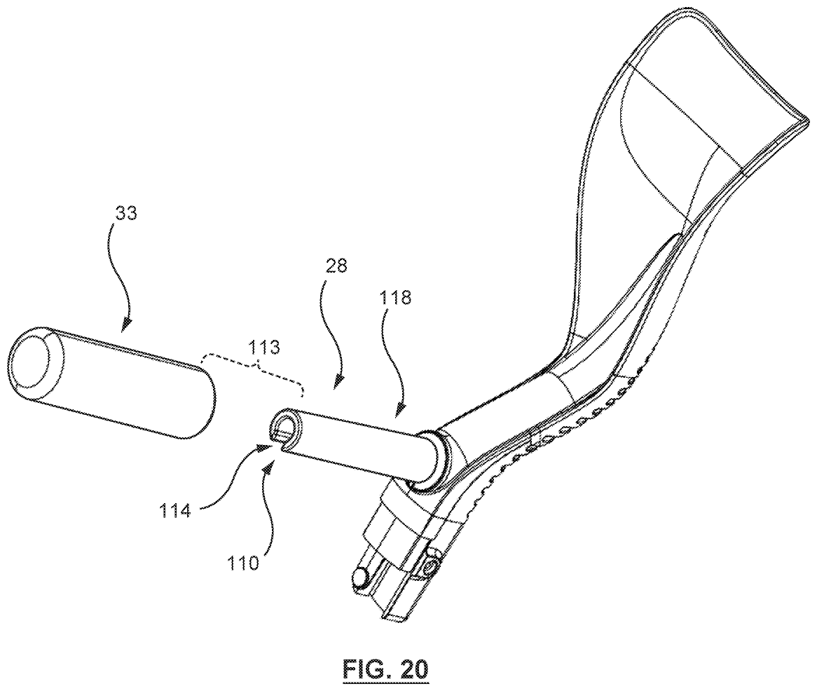

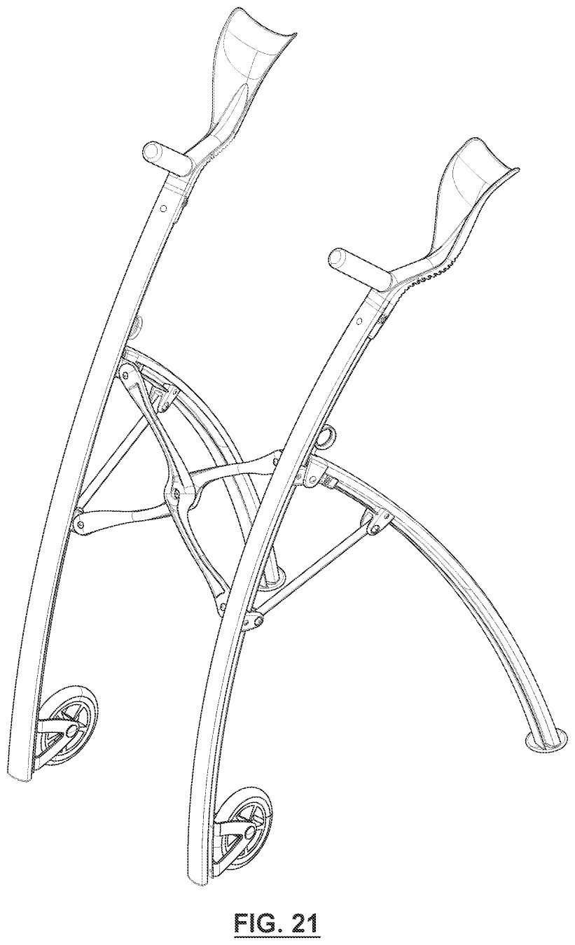

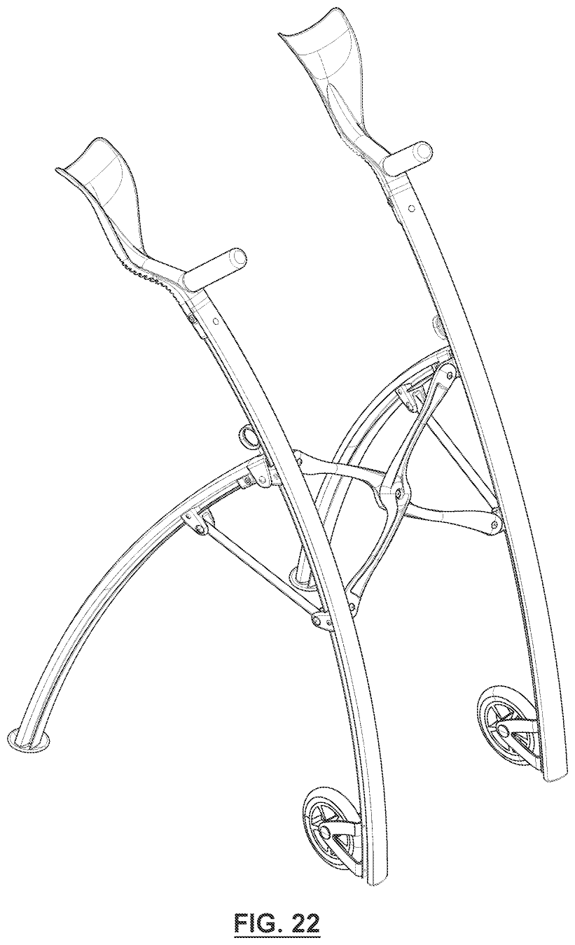

Referring to FIGS. 19, 20, each of the first handle portion 28 and hand grip structure 33 may include one or more complementary formations 110, 112 configured to form an interface 113 therebetween to orient each of the hand grips to a designated operative orientation. At least one of the formations may include at least one elongate receiver 114 on the first handle portion 28 and/or the hand grip structure, to receive a projection 116 formed on the other of the first handle portion 28 and/or the hand grip structure 33. At least one of the formations, in this case the first handle portion 28, may include a tubular structure 118 defining the receiver along a side wall thereof. The hand grip structure 33 may include a hand grip body 120 which may be configured and oriented along a central axis thereof to form the designated orientation. The hand grip body 120 may be custom configurable to one or more physical characteristics of a forearm and/or a hand of the standing ambulatory standing user, as may be constructed by 3D printing and other similar technologies, for example by carrying out a custom fitting process beforehand.

While the present disclosure describes various example embodiments, the disclosure is not so limited. To the contrary, the disclosure is intended to cover various modifications and equivalent arrangements, as will be readily appreciated by the person of ordinary skill in the art.

1. An ambulatory support device comprising:
an undercarriage configured, when operative, to travel along a floor surface and to present a pair of upper regions accessible by an ambulatory standing user,
a pair of handle structures for hand-grippable engagement by the ambulatory standing user,
each of the handle structures including
a first handle portion,
a second handle portion, and
a forearm support portion,
wherein:
the first handle portion and the forearm support portion are configured for the ambulatory standing user to navigate the device in a first operative mode with the undercarriage traversing the floor surface, and
the second handle portion and the forearm support portion are configured for the ambulatory standing user to lift at least a portion of the undercarriage off the floor surface in a second operative mode.

2. (canceled)

3. The device of claim 1, wherein the first handle portion is configured to be at an acute included angle relative to the floor surface, in the first operative mode.

4. The device of claim 1, wherein the undercarriage includes a pair of support structures, wherein each support structure is configured to support a respective handle structure.

5. The device of claim 4, wherein each of the support structures includes a first support portion configured in an expanded configuration to extend from a lower front floor engaging region to an upper handle structure engaging region.

6. The device of claim 5, wherein each of the support structures includes a second support portion configured in the expanded configuration to extend from a lower rear floor engaging region of the undercarriage to a central location along the first support structure.

7. The device of claim 5, wherein each of the first support portions has a curvature relative to a relatively rearward radial reference region.

8. The device of claim 6, wherein each of the second support portions has a curvature relative to a relatively forward radial reference region.

9. The device of claim 5, wherein each of the first support portions includes a wheel structure in the lower front floor engaging region to engage the floor surface.

10. The device of claim 6, wherein each of the second support portions includes a pad structure located in the lower rear floor engaging region to engage the floor surface.

11.-23. (canceled)

24. The device of claim 1, wherein the first handle portion, the second handle portion and the forearm support portion are aligned along a common handle structure axis.

25. The device of claim 1, wherein the second handle portion is between the first handle and the forearm support portion.

26. The device of claim 1, wherein the second handle portion is configured with a curved transition in a leading region thereof to provide a location at which the ambulatory standing user can terminate a hand grip to lift at least a portion of the device off the floor in the second operative mode.

27.-31. (canceled)

32. The device of claim 1, further comprising a pair of hand grip structures, each to engage a corresponding first handle portion.

33. The device of claim 32, wherein each of the hand grip structure and first handle portion include one or more complementary formations configured to form an interface therebetween to orient each of the hand structures to a designated operative orientation.

34.-35. (canceled)

36. The device of claim 33, wherein the hand grip structures include a hand grip body which is configured and/or oriented along a central axis thereof to form the designated orientation.

37. The device of claim 36, wherein the hand grip body is custom configurable to one or more physical characteristics of a forearm and/or a hand of the standing ambulatory standing user.

38. (canceled)

39. An ambulatory support device comprising an undercarriage configured to travel along a floor surface and to present a pair of handle structure receiving regions, a pair of modular handle structures, each of which is configured to be releasably coupled to a corresponding handle structure receiving region, each of the modular handle structures including a first handle portion, a second handle portion, and a forearm support portion, wherein the first handle portion and the forearm support portion are configured for the ambulatory standing user to navigate the device in a first operative mode with the undercarriage traversing the floor surface, and wherein the second handle portion and the forearm support portion are configured for the ambulatory standing user to lift at least a portion of the undercarriage off the floor surface in a second operative mode.

40. The device of claim 39, wherein one or both of the modular handle structures or portions thereof are configurable to one or more physical characteristics of a corresponding forearm and/or a corresponding hand of the ambulatory standing user.

41.-51. (canceled)

52. The device of claim 39, wherein the second handle portion is between the first handle and the forearm support portion.

53. The device of claim 52, wherein the first handle portion is configured to be at an acute included angle relative to the floor surface, in the first operative mode.

54. The device of claim 53, wherein the first handle portion, the second handle portion and the forearm support portion are aligned along a common handle structure axis.

55. The device of claim 54, wherein the second handle portion is configured with a curved transition in a leading region thereof to provide a location at which an ambulatory standing user can terminate a hand grip to lift at least a portion of the device off the floor in the second operative mode.
